(19) United States
(12) Patent Application Publication
(10) Pub. No.: US 2006/0053205 A1
(43) Pub. Date: Mar. 9, 2006

(54) Method and device for distinguishing user HTTP requests

(76) Inventors: Anne Boutroux, Hermanville Sur Mer (FR); Cedric Goutard, Douvres La Delivrance (FR)

Correspondence Address: FISH & RICHARDSON P.C., P.O. BOX 1022, MINNEAPOLIS, MN, 55440-1022, US

(21) Appl. No.: 11/192,708

(22) Filed: Jul. 29, 2005

(30) Foreign Application Priority Data
Jul. 29, 2004 (FR) 04 08410

(51) Int. Cl. G06F 15/16

(52) U.S. Cl. 709/206

(57) ABSTRACT

The invention relates to a method for distinguishing an HTTP request sent over a telecommunications network from a client device equipped with a browser to a Web server, characterised in that the HTTP request is marked when said request is sent explicitly by the user. Thus, the invention makes it possible to distinguish between explicit user requests and implicit browser requests for the purpose of operating in the network.

This invention relates to the field of communication between Internet telecommunications network equipment, in particular between a client device and a Web server.

The invention more specifically relates to a method and a device for distinguishing HTTP requests sent over a telecommunications network from a client device equipped with a browser to a Web server.

The communication between a client device and a Web server is indeed based on the HTTP protocol (for “Hypertext Transfer Protocol”). In practice, the HTTP protocol enables access, via the telecommunications network, to files essentially in HTML format (“Hypertext Markup Language”), which are identified by a single address referred to as a URL (“Uniform Resource Locator”) The HTTP protocol thus enables HTML files to be exchanged between a client device and a Web server.

The client device must be equipped with a specific resource, referred to as a browser, which is the client software capable of interrogating Web servers, exploiting their results and laying out information on a page by means of instructions contained in the HTML page.

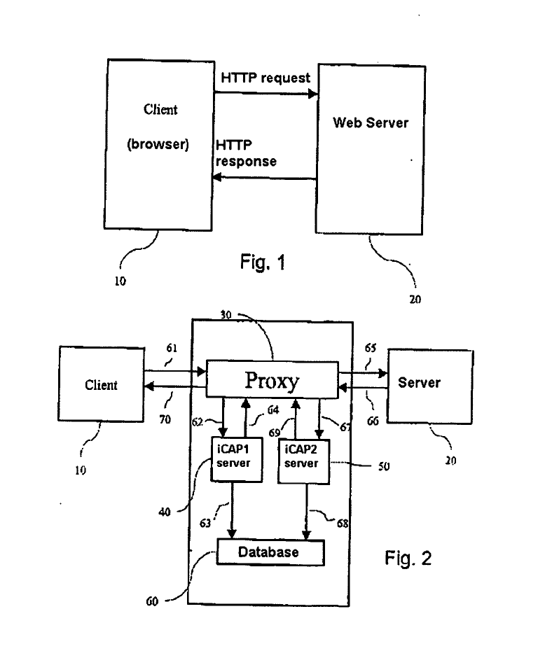

When a browser makes a request, typically when a user enters or clicks on a URL, the communication between the browser and the Web server occurs as follows, as shown schematically in FIG. 1:

the request data is sent to the server 20 by the client device 10 in the form of an access method, a URL, a protocol version and HTTP request headers, in particular enabling the file requested, the requester's IP address, and so on, to be identified.

when the server 20 receives the HTTP request, it processes the request by analysing the access method, the URL, the protocol version and the HTTP headers, in particular the element enabling the requested file to be located, then sends an HTTP response to the client device (the browser).

A proxy server can also be used in the context of HTTP communication between the client device and the Web server. Thus, when a user connects to the Internet by means of a browser configured to use a proxy server, it will connect first to the proxy server and give it the request. The proxy server will then connect to the server to which the browser is trying to connect and send the request to it. The server will then give its response to the proxy, which will then send it to the browser.

The client device 10 is typically a computer, but can be replaced by any other equipment capable of sending an HTTP request. Similarly, the proxy server can be replaced by a router or by any other Internet equipment.

The HTML page received by the browser in response and which corresponds to the URL requested by the user, also includes a plurality of objects provided to satisfy display and layout requirements, for example, and which are based on an interpretation of the HTML code received by the browser. Indeed, the HTML code of the page requested by the user contains references to objects forming the page.

These objects can be images, logos or even style sheets.

All of these different objects in the page were not therefore obtained upon the explicit request of the user, that is by the user's entry of a URL in the browser or activation of a hypertext link, but in fact correspond to URLs requested implicitly by the browser when the Web page is displayed and laid out.

Therefore, HTTP requests sent explicitly by the user (entry of a URL in the browser or clicking on a hypertext link) can be distinguished from HTTP requests implicitly sent by the browser, for example for the purpose displaying and laying out, which are the consequence of the first explicit request by the user.

Currently, the HTTP protocol has no standard specification nor an implementation enabling a browser to make such a distinction between explicit HTTP requests from a user and “implicit” requests generated by the browser when a Web page is displayed and laid out.

However, requests implicitly sent by the browser can be considered to be noise, and restrict the placement of value-added services in the network on the basis of an analysis and follow-up of user requests. Implicit requests are thus inevitably catalogued and do not make it possible to obtain a representation of Internet user browsing information that can be adequately run, for example, for a profiling service.

Moreover, one aim of this invention is to overcome these disadvantages by making it possible to distinguish, for the purpose of operating in the network, between explicit user requests and implicit browser requests.

With this objective in view, the subject matter of the invention is a method for managing HTTP requests transmitted over a telecommunications network from a client device equipped with a browser to a Web server, characterised in that it includes a step consisting of making a distinction between requests sent explicitly by the user and requests sent implicitly by the browser of the client device.

Advantageously, the step of distinguishing requests includes the marking of HTTP requests transmitted explicitly by the user.

An HTTP request sent explicitly by the user corresponds to the user's entry of a URL address in the browser or to the activation by a user of a hypertext link.

According to an embodiment, the marking of the HTTP request is performed by the browser of the client device.

According to another embodiment, the marking of the HTTP request is performed by a service built into the network.

According to the latter embodiment, the service built into the network implements the following steps, consisting of:

a—receiving a first HTTP request from the client device;

b—marking said request;

c—sending said request to the server;

d—receiving the corresponding HTTP response from the server;

e—storing, in a database, the URLs corresponding to objects included in said response capable of leading to HTTP requests implicitly requested by the browser;

f—sending said response to the client device and,

g—for each subsequent HTTP request received from the client device and not referenced in said database, repeat steps b to g.

Preferably, an expiration date is associated with each URL stored in the database, and all of the URLs in the database for which the expiration date has passed are deleted.

Advantageously, the IP address of the client device is associated with each URL stored in the database.

Preferably, the marking of the HTTP request consists of the addition of a specific header in said HTTP request.

The invention also relates to a device for distinguishing HTTP requests sent over a telecommunications network from a client device equipped with a browser to a Web server, characterised in that it includes:

network equipment capable of receiving HTTP requests from the client device and sending them to the Web server and receiving the corresponding responses from the server and sending them to the client device,

a module for processing responses received from the Web server by said network equipment, including means for determining the URL corresponding to objects included in said responses capable of leading to HTTP requests implicitly requested by the browser,

a database for storing said URLs, and

a module for processing requests received from the client device by said network equipment, including means for marking said requests if they are not referenced in said database.

According to an embodiment, the module for processing HTTP requests includes an iCAP server and the module for processing HTTP responses includes an iCAP server.

The invention also relates to a computer program for implementing the method according to the invention.

The invention also relates to a web server capable of receiving HTTP requests sent over a telecommunications server from a client device, characterised in that, as the HTTP requests received include a specific mark according to whether or not they correspond to a request sent explicitly by the user of the client device, said server has means capable of distinguishing, on the basis of said mark, a request sent implicitly from a request sent explicitly.

The invention also relates to a computer program to be implemented on a server capable of receiving HTTP requests sent over a telecommunications network from a client device, characterised in that, as the HTTP requests received include a specific mark according to whether or not they correspond to a request sent explicitly by the user, said program can distinguish, from the server, between requests sent explicitly and requests sent implicitly.

Other characteristics and advantages of this invention will be more clear from the following description given as an illustrative and non-limiting example, in reference to the appended figures, in which,

FIG. 1, already described, schematically shows the communication process between a client device and a Web server according to the HTTP protocol, and

FIG. 2 shows an embodiment of the invention.

According to a first embodiment of the invention, when the HTTP request results from an action by the user on the browser, the latter is provided to mark the request before sending it to the requested Web server. The user's action on the browser involves entering a URL address in the browser or activating a hypertext link.

According to a preferred embodiment of the invention, the marking of the request by the browser consists of adding a specific field to the HTTP header of the request. The HTTP header added can, for example, be in the following form:

“X-UserAction: Explicit”

However, the following requests implicitly sent by the browser and typically corresponding to objects referenced in the content of the HTTP response received, will not be marked by the browser.

A second embodiment is described in reference to FIG. 2, in which the function of marking explicit HTTP requests is transferred to a device built into the network.

Such a device according to the invention includes network equipment 30, capable of receiving HTTP requests from the client device 10 and sending them to the Web server 20, as well as receiving the corresponding HTTP responses from the Web server 20 and sending them to the client device 10. The network equipment 30 can be a proxy server. It can also be a router, a switch or any other equipment providing an equivalent function.

The device according to the invention also includes a module 50 for processing HTTP responses received from the Web server 20 by the proxy server 30. The module for processing responses 50 includes means for determining the URL addresses corresponding to objects included in the HTTP responses capable of leading to implicit HTTP requests from the browser of the client device. Once these addresses have been determined, the module 50 extracts them and writes them into a database 60 provided for storing these URL addresses.

The device according to the invention also includes a module 40 for processing HTTP requests received from the client device 10 by the proxy server 30, including means for marking the requests if they are not referenced in the database 60. The database 60 therefore includes means for connecting with processing modules 40 and 50.

According to a first embodiment, the functions implemented by modules 40 and 50 can be implemented directly on the proxy server 30.

According to another embodiment, the functions for processing HTTP requests and responses are transferred from the proxy server to an iCAP server. Advantageously, the module for processing HTTP requests is implemented on a first iCAP1 server, and the module for processing HTTP responses is implemented on a second iCAP2 server.

Thus, the communication between the proxy server 30 and the processing modules 40 and 50 is based on a protocol for adapting iCAP content (“Internet Content Adaptation Protocol”) defined by a group of companies in the context of an iCAP forum. The use of iCAP servers for implementing modules 40 and 50 thus makes it possible to work with any proxy server, owing to the general communication protocol used.

The device built into the network, combining the proxy server 30, processing modules 40 and 50, implemented in the embodiment by iCAP1 and iCAP2 servers, and the database 60 implements, as will now be shown in greater detail, a cross-analysis between the HTTP requests and corresponding responses, enabling a distinction to be made between explicit requests and implicit requests.

Thus, the mechanism for distinguishing requests follows the following steps, in reference to FIG. 2:

The proxy server 30 receives 61 the first request from the client device 10 identified by its IP address (IP1).

The proxy server sends 62 this request to the iCAP1 server 40, as well as the IP address (IP1) of the client device.

The iCAP1 server verifies 63 in the database 60 whether this request is referenced in the database for this IP address. In fact, since it is a first request from a new client, it is not referenced and the iCAP1 server marks the request. More specifically, it inserts a specific field into the HTTP request header. The HTTP header added can, for example, be in the following form:

“X-UserAction: Explicit”

The iCAP1 server then sends 64 the marked request to the proxy server 30.

The proxy server 30 sends 65 this request to the Web server 20, or generally through the following elements of the network to the server 20.

The proxy server 30 receives 66 the HTTP response to this request and sends 67 it to the iCAP2 server, as well as the IP address IP1 of the client device 10.

The iCAP2 server analyses this response and extracts from the document, if it is a text document that can be run by the browser (HTML page, list of files in a directory), links to objects included in the object that constitutes the response, which are capable of leading to implicit requests generated by the browser of the client device 10 upon its receipt of the response. These objects included are referenced in the response, in particular with an “IMG”- or “SRC”-type HTML code. These links extracted by the iCAP2 server are constituted by complete URL addresses to the objects included.

The iCAP2 server then adds 68 the list of URL addresses to the included objects to the database 60 for the IP address IP1, and, for each address added to the database, preferably generates an associated expiration date in the database, for example, of around thirty seconds. The database 60 therefore contains the following type of entry:

[Client IP Address (IP1) /URL/ Expiration Date]

Once these operations have been carried out, the iCAP2 server 50 returns 69 the response to the proxy server 30, which sends 70 it to the client device 10.

The client device receives the response and sends the next requests, for which the distinguishing method described above according to steps 61 to 70 is repeated. The mechanism repeats itself as long as the client device is connected. The next requests transmitted may correspond to the objects included in the response previously received.

Thus, the proxy server 30 receives 61 a next request from the client device 10 identified by its IP address IP1, and sends 62 this next request to the iCAP1 server, as well as the client's IP1 address.

The iCAP1 server then verifies 63 in the database 60 that this request is referenced in the database for this IP address. If it is not, it means that the request does not correspond to any URL address stored in the database for this IP address and therefore that it is an explicit request from the user. The iCAP1 server then inserts the specific field “X-UserAction: explicit” in the HTTP request header, signifying that it is an explicit user request.

However, if the request is referenced in the database and the associated expiration date has not passed, the iCAP1 server does not mark the request.

The request is then returned 64 to the proxy server 30 and the distinguishing process continues according to the steps already described as long as the client is connected.

Simultaneously, a database 60 cleaning process is implemented, consisting of removing all URL addresses for which the expiration date has passed from the database. This process makes it possible not only to maintain a reasonable database size, but also to remove any reference to a client device that is no longer connected.

Thus, the addition of a specific mark by the browser or a system built into the network when the HTTP request follows an explicit user action makes it possible to obtain very specific information on the path of the user and his or her real actions.

By distinguishing requests explicitly requested by the user, obtained by means of the invention, a plurality of value-added services can be provided. As regards the Internet access provider, a service for analysis and follow-up on explicit requests from users can thus be capable of tracing the URLs actually requested by a user to generate an explicit browsing tree for the user. The profile of users thus obtained can thus be validated, in particular with publicity agents.

Presence management services at the application level can also be implemented. For example, it is possible to determine the most recent URL actually requested by the user (and not the browser) in order to send him or her certain information on the basis of this URL.

Similarly, at the level of Web server history files, a validation service can follow the path of explicit user requests so as to determine, for example, the appropriate positioning of publicity or even to propose modifications for faster access to the data.

The entire description above was drafted in a context in which the communication between the client device and the server is based on the use of the HTTP protocol. However, it should be noted that this invention can be applied to other protocols, current and future, for which there is a problem of distinguishing between explicit and implicit requests.

1. Method for managing HTTP requests transmitted over a telecommunications network from a client device equipped with a browser to a Web server, characterised in that it includes a step consisting of making a distinction between requests sent explicitly by the user and requests sent implicitly by the browser of the client device.

2. Method according to claim 1 characterised in that the step of distinguishing requests includes the marking of HTTP requests transmitted explicitly by the user.

3. Method according to claim 1, characterised in that an HTTP request sent explicitly by the user corresponds to the user's entry of a URL address in the browser or the user's activation of a hypertext link.

4. Method according to claim 2, characterised in that HTTP requests are marked by the browser of the client device.

5. Method according to claim 2, characterised in that HTTP requests are marked by a service built into the network.

6. Method according to claim 5, characterised in that the service built into the network implements the following steps consisting of:
a—receiving a first HTTP request from the client device;
b—marking said request;
c—sending said request to the server;
d—receiving the corresponding HTTP response from the server;
e—storing, in a database, the URLs corresponding to objects included in said response capable of leading to HTTP requests implicitly requested by the browser;
f—sending said response to the client device and,
g—for each subsequent HTTP request received from the client device and not referenced in said database, repeat steps b to g.

7. Method according to claim 6, characterised in that an expiration date is associated with each URL stored in the database, and in that all of the URLs in the database for which the associated expiration date has passed are deleted.

8. Method according to claim 6, characterised in that the IP address of the client device is associated with each URL stored in the database.

9. Method according to claim 2, characterised in that the marking of HTTP requests consists of adding a specific header in said HTTP requests.

10. Device for distinguishing HTTP requests sent over a telecommunications network from a client device equipped with a browser to a Web server, characterised in that it includes:
network equipment capable of receiving HTTP requests from the client device and sending them to the Web server and receiving the corresponding responses from the server and sending them to the client device,
a module for processing responses received from the Web server by said network equipment, including means for determining the URL corresponding to objects included in said responses capable of leading to HTTP requests implicitly requested by the browser,
a database for storing said URLs, and
a module for processing requests received from the client device by said network equipment, including means for marking said requests if they are not referenced in said database.

11. Device according to claim 10, characterised in that the module for processing HTTP requests includes an iCAP server.

12. Device according to claim 10, characterised in that the module for processing HTTP responses includes an iCAP server.

13. Computer program for implementing the method for managing HTTP requests on the client device side according to claim 1.

14. Web server capable of receiving HTTP requests sent over a telecommunications server from a client device, characterised in that, as the HTTP requests received include a specific mark according to whether or not they correspond to a request sent explicitly by the user of the client device, said server has means capable of distinguishing, on the basis of said mark, a request sent implicitly from a request sent explicitly.

15. Computer program to be implemented on a server capable of receiving HTTP requests sent over a telecommunications network from a client device, characterised in that, as the HTTP requests received include a specific mark according to whether or not they correspond to a request sent explicitly by the user, said program can distinguish, from the server, between requests sent explicitly and requests sent implicitly.
